(19) United States
(12) Patent Application Publication
(10) Pub. No.: US 2017/0289776 A1
(43) Pub. Date: Oct. 5, 2017

(54) METHOD FOR ESTABLISHING MCPTT GROUP CALL IN WIRELESS COMMUNICATION SYSTEM AND DEVICE THEREFOR

(71) Applicant: LG ELECTRONICS INC., Seoul (KR)

(72) Inventors: Laeyoung KIM, Seoul (KR); Jinsook RYU, Seoul (KR); Hyunsook KIM, Seoul (KR); Jaehyun KIM, Seoul (KR); Taehun KIM, Seoul (KR)

(73) Assignee: LG ELECTRONICS INC., Seoul (KR)

(21) Appl. No.: 15/509,628

(22) PCT Filed: Sep. 11, 2015
(86) PCT No.: PCT/KR2015/009572

§ 371 Date: Mar. 8, 2017

Related U.S. Application Data
(60) Provisional application No. 62/049,320, filed on Sep. 11, 2014.

(51) Int. Cl. H04W 4/08

(52) U.S. Cl. CPC H04W 4/08; H04W 4/10

(57) ABSTRACT

One embodiment of the present invention relates to a method by which a mission critical push to talk (MCPTT) server establishes a group call in a wireless communication system, comprising the steps of: determining whether to add a user equipment (UE) to an ongoing group call; transmitting information relating to the ongoing group call to the UE if it is determined that the UE is added to the ongoing group call; and receiving an OK response for the ongoing group call from the UE.

### TECHNICAL FIELD

The present invention relates to a wireless communication system, and more particularly, to a method for establishing a mission critical push to talk (MCPTT) group call and a device therefor.

### BACKGROUND ART

Wireless access systems have been widely deployed to provide various types of communication services such as voice or data. In general, a wireless access system is a multiple access system that may support communication of multiple users by sharing available system resources (e.g., a bandwidth, transmission power, etc.). For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a multi carrier frequency division multiple access (MC-FDMA) system.

### DISCLOSURE

### Technical Problem

An object of the present invention is to provide a method for adding a UE to an ongoing call, which already exists, in a group call establishment.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

In one embodiment of the present invention, a method for establishing a group call in an MCPTT (Mission Critical Push To Talk) server in a wireless communication system comprises the steps of determining whether to add a user equipment (UE) to an ongoing group call; transmitting information on the ongoing group call to the UE if it is determined that the UE is added to the ongoing group call; and receiving an OK response to the ongoing group call from the UE.

The step of determining whether to add the UE to the ongoing group call may be performed by receiving the information on the group call from the UE.

The information on the group call may be a group call request. The step of determining whether to add the UE to the ongoing group call may be performed by receiving information on network connection from the UE.

The information on network connection may be transmitted after switching from an out of coverage status to an in coverage status.

The information on network connection may be registration or re-registration to the MCPTT server.

The UE may be an affiliated MCPTT member.

The step of determining whether to add the UE to the ongoing group call may be performed when the MCPTT server recognizes one or more of end of the group call to which the UE belongs, non-participation of the UE in the ongoing group call, and non-participation of the UE in the ongoing group call despite that the UE may join the ongoing group call.

In another embodiment of the present invention, an MCPTT (Mission Critical Push To Talk) server for establishing a group call in a wireless communication system comprises a transceiving device; and a processor, wherein the processor determines whether to add a user equipment (UE) to an ongoing group call, transmits information on the ongoing group call to the UE if it is determined that the UE is added to the ongoing group call, and receives receiving an OK response to the ongoing group call from the UE.

The determination as to whether to add the UE to the ongoing group call may be performed by receiving the information on the group call from the UE.

The information on the group call may be a group call request.

The determination as to whether to add the UE to the ongoing group call may be performed by receiving information on network connection from the UE.

The information on network connection may be transmitted after switching from an out of coverage status to an in coverage status.

The information on network connection may be registration or re-registration to the MCPTT server.

The UE may be an affiliated MCPTT member.

The determination as to whether to add the UE to the ongoing group call may be performed when the MCPTT server recognizes one or more of end of the group call to which the UE belongs, non-participation of the UE in the ongoing group call, and non-participation of the UE in the ongoing group call despite that the UE may join the ongoing group call.

### Advantageous Effects

According to the present invention, since a UE may add to an ongoing group call, which already exists, MCPTT may be managed efficiently.

It will be appreciated by persons skilled in the art that that the effects that can be achieved through the present invention are not limited to what has been particularly described hereinabove and other advantages of the present invention will be more clearly understood from the following detailed description.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 is a diagram illustrating a brief structure of an evolved packet system (EPS) that includes an evolved packet core (EPC).

FIG. 2 is an exemplary diagram illustrating an architecture of a general E-UTRAN and a general EPC.

FIG. 3 is an exemplary diagram illustrating a structure of a radio interface protocol on a control plane.

FIG. 4 is an exemplary diagram illustrating a structure of a radio interface protocol on a user plane.

FIG. 5 is a flow chart illustrating a random access procedure.

FIG. 6 is a diagram illustrating a connection procedure in a radio resource control (RRC) layer.

FIGS. 7 to 9 are diagrams illustrating MCPTT.

FIGS. 10 to 12 are diagrams illustrating one embodiment of the present invention.

FIG. 13 is a diagram illustrating a node device according to the embodiment of the present invention.

### BEST MODE FOR CARRYING OUT THE INVENTION

The embodiments below are combinations of components and features of the present invention in a prescribed form. Each component or feature may be considered as selective unless explicitly mentioned as otherwise. Each component or feature may be executed in a form that is not combined with other components and features. Further, some components and/or features may be combined to configure an embodiment of the present invention. The order of operations described in the embodiments of the present invention may be changed. Some components or features of an embodiment may be included in another embodiment or may be substituted with a corresponding component or feature of the present invention.

Specific terms used in the description below are provided to help an understanding of the present invention, and the use of such specific terms may be changed to another form within the scope of the technical concept of the present invention.

In some cases, in order to avoid obscurity of the concept of the present invention, a known structure and apparatus may be omitted, or a block diagram centering on core functions of each structure or apparatus may be used. Moreover, the same reference numerals are used for the same components throughout the present specification.

The embodiments of the present invention may be supported by standard documents disclosed with respect to at least one of IEEE (Institute of Electrical and Electronics Engineers) 802 group system, 3GPP system, 3GPP LTE & LTE-A system and 3GPP2 system. Namely, the steps or portions having not been described in order to clarify the technical concept of the present invention in the embodiments of the present invention may be supported by the above documents. Furthermore, all terms disclosed in the present document may be described according to the above standard documents.

The technolgy below may be used for various wireless communciation systems. For clarity, the description below centers on 3GPP LTE and 3GPP LTE-A, by which the technical idea of the present invention is non-limited.

Terms used in the present document are defined as follows.
UMTS (Universal Mobile Telecommunications System): a GSM (Global System for Mobile Communication) based third generation mobile communication technology developed by the 3GPP.
EPS (Evolved Packet System): a network system that includes an EPC (Evolved Packet Core) which is an IP (Internet Protocol) based packet switched core network and an access network such as LTE and UTRAN. This system is the network of an evolved version of the UMTS.
NodeB: a base station of GERAN/UTRAN. This base station is installed outdoor and its coverage has a scale of a macro cell.
eNodeB: a base station of LTE. This base station is installed outdoor and its coverage has a scale of a macro cell.
UE (User Equipment): the UE may be referred to as terminal, ME (Mobile Equipment), MS (Mobile Station), etc. Also, the UE may be a portable device such as a notebook computer, a cellular phone, a PDA (Personal Digital Assistant), a smart phone, and a multimedia device. Alternatively, the UE may be a non-portable device such as a PC (Personal Computer) and a vehicle mounted device. The term “UE”, as used in relation to MTC, can refer to an MTC device.
HNB (Home NodeB): a base station of UMTS network. This base station is installed indoor and its coverage has a scale of a micro cell.
HeNB (Home eNodeB): a base station of an EPS network. This base station is installed indoor and its coverage has a scale of a micro cell.
MME (Mobility Management Entity): a network node of an EPS network, which performs mobility management (MM) and session management (SM).
PDN-GW (Packet Data Network-Gateway)/PGW: a network node of an EPS network, which performs UE IP address allocation, packet screening and filtering, charging data collection, etc.
SGW (Serving Gateway): a network node of an EPS network, which performs mobility anchor, packet routing, idle-mode packet buffering, and triggering of an MME's UE paging.
NAS (Non-Access Stratum): an upper stratum of a control plane between a UE and an MME. This is a functional layer for transmitting and receiving a signaling and traffic message between a UE and a core network in an LTE/UMTS protocol stack, and supports mobility of a UE, and supports a session management procedure of establishing and maintaining IP connection between a UE and a PDN GW.
PDN (Packet Data Network): a network in which a server supporting a specific service (e.g., a Multimedia Messaging Service (MMS) server, a Wireless Application Protocol (WAP) server, etc.) is located.
PDN connection: a logical connection between a UE and a PDN, represented as one IP address (one IPv4 address and/or one IPv6 prefix).
RAN (Radio Access Network): a unit including a Node B, an eNode B, and a Radio Network Controller (RNC) for controlling the Node B and the eNode B in a 3GPP network, which is present between UEs and provides a connection to a core network.
HLR (Home Location Register)/HSS (Home Subscriber Server): a database having subscriber information in a 3GPP network. The HSS can perform functions such as configuration storage, identity management, and user state storage.
PLMN (Public Land Mobile Network): a network configured for the purpose of providing mobile communication services to individuals. This network can be configured per operator.
Proximity Services (or ProSe Service or Proximity-based Service): a service that enables discovery between physically proximate devices, and mutual direct communication/communication through a base station/communication through the third party. At this time, user plane data are exchanged through a direct data path without through a 3GPP core network (for example, EPC).
ProSe Communication: communication between two or more ProSe-enabled UEs in proximity by means of a ProSe Communication path. Unless explicitly stated otherwise, the term “ProSe Communication” refers to any/all of the following: ProSe E-UTRA Communication, ProSe-assisted WLAN direct communication between two UEs, ProSe Group Communication and ProSe Broadcast Communication.
ProSe E-UTRA Communication: ProSe Communication using a ProSe E-UTRA Communication path.
ProSe-assisted WLAN direct communication: ProSe Communication using a ProSe-assisted WLAN direct communication path.
ProSe Communication path: communication path supporting ProSe Communication. The ProSe E-UTRA Communication path could be established between the ProSe-enabled UEs using E-UTRA, or routed via local eNB(s). The ProSe-assisted WLAN direct communication path may be established directly between the ProSe-enabled UEs using WLAN.
EPC Path (or infrastructure data path): the user plane communication path through EPC.
ProSe Discovery: a process that identifies that a UE that is ProSe-enabled is in proximity of another, using E-UTRA.
ProSe Group Communication: one-to-many ProSe Communication, between more than two ProSe-enabled UEs in proximity, by means of a common communication path established between the ProSe-enabled UEs.
ProSe UE-to-Network Relay: is a form of relay in which a ProSe-enabled Public Safety UE acts as a communication relay between a ProSe-enabled Public Safety UE and the ProSe-enabled network using E-UTRA.
ProSe UE-to-UE Relay: is a form of relay in which a ProSe-enabled Public Safety UE acts as a ProSe Communication relay between two or more ProSe-enabled Public Safety UEs.
Remote UE: This is a Prose-enabled public safety UE connected to EPC through Prose UE-to-Network Relay without service from E-UTRAN in a UE-to-Network Relay operation, that is, Prose-enabled public safety UE configured to receive PDN connection, whereas this is a Prose-enabled public safety UE that performs communication with other Prose-enabled public safety UE through a Prose UE-to-UE Relay in a UE-to-UE relay operation.
ProSe-enabled Network: a network that supports ProSe Discovery, ProSe Communication and/or ProSe-assisted WLAN direct communication. Hereinafter, the ProSe-enabled Network may simply be referred to as a network.
ProSe-enabled UE: a UE that supports ProSe Discovery, ProSe Communication and/or ProSe-assisted WLAN direct communication. Hereinafter, the ProSe-enabled UE and the ProSe-enabled Public Safety UE may be referred to as UE.
Proximity: proximity is determined (“a UE is in proximity of another UE”) when given proximity criteria are fulfilled. Proximity criteria can be different for discovery and communication.
SLP(SUPL Location Platform): entity that controls Location Service Management and Position Determination. The SLP includes SLC(SUPL Location Center) function and SPC(SUPL Positioning Center) function. Details of the SLP will be understood with reference to Open Mobile Alliance(OMA) standard document OMA AD SUPL: “Secure User Plane Location Architecture”.
USD(User Service Description): application/service layer transmits USD, which includes TMGI(Temporary Mobile Group Identity) for each MBMS service, start and end time of session, frequencies, and MBMS service area identities(MBMS SAIs) information belonging to MBMS service area, to the UE. Details of the USD will be understood with reference to 3GPP TS 23.246.
ISR (Idle mode Signaling Reduction): When a UE frequently moves between E-UTRAN and UTRAN/GERAN, waste of network resources occurs due to a repeated position registration process. As a method for reducing such a waste, when the UE is in an idle mode, after position registration for MME and SGSN (hereinafter, these two nodes will be referred to as mobility management node) is performed through the E-UTRAN and the UTRAN/GERAN, a separate position registration is not performed in the case that movement between two RATs (Radio Access Technologies) which are already registered or cell reselection is performed. Therefore, if DL (downlink) data to the corresponding UE is arrived, paging is transmitted to the E-UTRAN and the UTRAN/GERAN at the same time to successfully discover the UE, whereby the DL data may be transferred to the discovered UE. [see 3GPP TS 23.401 and 3GPP TS 23.060]
Mission Critical Push To Talk: a group communication service that provides a fast establishment time, a capability capable of processing a large scaled group, powerful security, and priority handling.
MCPTT service: a Push To Talk communication service that supports applications for Mission Critical Organizations and mission critical applications for other businesses and organizations (e.g., utilities, railways), and provides a fast establishment time, high availability and reliability, and priority handling.
Mission Critical Organization: an end-user organization that includes MCPTT users and UEs, and may include MCPTT Administrators. This organization may be delegated within the organization, or may be organized hierarchically under the administrative control delegated to an external entity.
MCPTT system: a set of applications, services, and enabling capabilities, which are required to support Mission Critical Push To Talk for Mission Critical Organization.
MCPTT User: a user of MCPTT service, and a user having a device (that is, UE) that may join MCPTT service.
MCPTT Group: a defined set of MCPTT users who may be identified regardless of (or independently from) transport or network type.
MCPTT Group Member: MCPTT user authorized to join group communication of a specific MCPTT Group.
Group call: mechanism that allows MCPTT user to transmit one-to-many MCPTT to other users who are members of MCPTT Group(s).
Group affiliation: mechanism that determines whether MCPTT user is interested in one or more MCPTT groups.
Affiliated MCPTT Group Member: MCPTT Group Member ready to receive and/or transmit group communication from and/or to a corresponding MCPTT group by announcing an interest in a random MCPTT group.
Late call entry: Affiliated MCPTT Group Member joins MCPTT Group Call which is ongoing.
Floor control: intervention system in MCPTT service, which determines a user having an authority for transmitting (talking) at a random time while an MCPTT call is ongoing.
The other MCPTT related terms apply to 3.1 Definitions of 3GPP TS 22.179 and 3.1 Definitions of TS 23.179.

Evolved Packet Core (EPC)

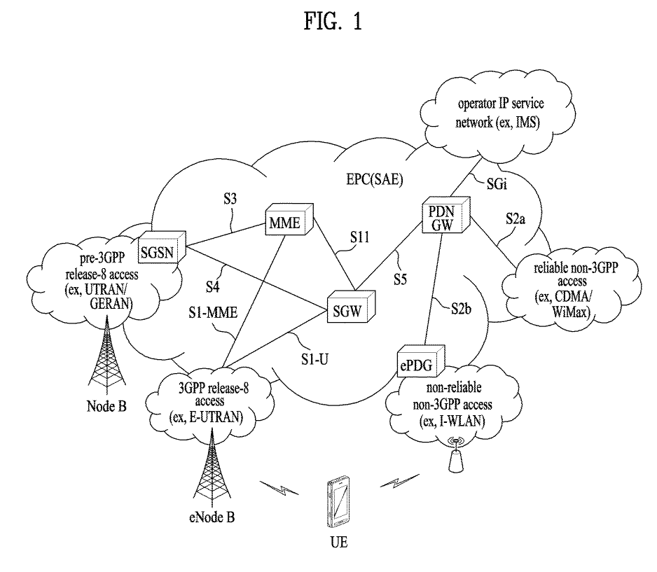

FIG. 1 is a schematic diagram showing the structure of an evolved packet system (EPS) including an evolved packet core (EPC).

The EPC is a core element of system architecture evolution (SAE) for improving performance of 3GPP technology. SAE corresponds to a research project for determining a network structure supporting mobility between various types of networks. For example, SAE aims to provide an optimized packet-based system for supporting various radio access technologies and providing an enhanced data transmission capability.

Specifically, the EPC is a core network of an IP mobile communication system for 3GPP LTE and can support real-time and non-real-time packet-based services. In conventional mobile communication systems (i.e. second-generation or third-generation mobile communication systems), functions of a core network are implemented through a circuit-switched (CS) sub-domain for voice and a packet-switched (PS) sub-domain for data. However, in a 3GPP LTE system which is evolved from the third generation communication system, CS and PS sub-domains are unified into one IP domain. That is, in 3GPP LTE, connection of terminals having IP capability can be established through an IP-based business station (e.g., an eNodeB (evolved Node B)), EPC, and an application domain (e.g., IMS). That is, the EPC is an essential structure for end-to-end IP services.

The EPC may include various components. FIG. 1 shows some of the components, namely, a serving gateway (SGW), a packet data network gateway (PDN GW), a mobility management entity (MME), a serving GPRS (general packet radio service) supporting node (SGSN) and an enhanced packet data gateway (ePDG).

The SGW operates as a boundary point between a radio access network (RAN) and a core network and maintains a data path between an eNodeB and the PDN GW. When. When a terminal moves over an area served by an eNodeB, the SGW functions as a local mobility anchor point. That is, packets. That is, packets may be routed through the SGW for mobility in an evolved UMTS terrestrial radio access network (E-UTRAN) defined after 3GPP release-8. In addition, the SGW may serve as an anchor point for mobility of another 3GPP network (a RAN defined before 3GPP release-8, e.g., UTRAN or GERAN (global system for mobile communication (GSM)/enhanced data rates for global evolution (EDGE) radio access network).

The PDN GW corresponds to a termination point of a data interface for a packet data network. The PDN GW may support policy enforcement features, packet filtering and charging support. In addition, the PDN GW may serve as an anchor point for mobility management with a 3GPP network and a non-3GPP network (e.g., an unreliable network such as an interworking wireless local area network (I-WLAN) and a reliable network such as a code division multiple access (CDMA) or WiMax network).

Although the SGW and the PDN GW are configured as separate gateways in the example of the network structure of FIG. 1, the two gateways may be implemented according to a single gateway configuration option.

The MME performs signaling and control functions for supporting access of a UE for network connection, network resource allocation, tracking, paging, roaming and handover. The MME controls control plane functions associated with subscriber and session management. The MME manages numerous eNodeBs and signaling for selection of a conventional gateway for handover to other 2G/3G networks. In addition, the MME performs security procedures, terminal-to-network session handling, idle terminal location management, etc.

The SGSN handles all packet data such as mobility management and authentication of a user for other 3GPP networks (e.g., a GPRS network).

The ePDG serves as a security node for a non-3GPP network (e.g., an I-WLAN, a Wi-Fi hotspot, etc.).

As described above with reference to FIG. 1, a terminal having IP capabilities may access an IP service network (e.g., an IMS) provided by an operator via various elements in the EPC not only based on 3GPP access but also on non-3GPP access.

Additionally, FIG. 1 shows various reference points (e.g. S1-U, S1-MME, etc.). In 3GPP, a conceptual link connecting two functions of different functional entities of an E-UTRAN and an EPC is defined as a reference point. Table 1 is a list of the reference points shown in FIG. 1. Various reference points may be present in addition to the reference points in Table 1 according to network structures.

TABLE 1

| Reference | |
|---|---|
| point | Description |
| S1-MME | Reference point for the control plane protocol between E-UTRAN and MME |
| S1-U | Reference point between E-UTRAN and Serving GW for the per bearer user plane |
| | tunneling and inter eNodeB path switching during handover |
| S3 | It enables user and bearer information exchange for inter 3GPP access network |
| | mobility in idle and/or active state. This reference point can be used intra-PLMN or |
| | inter-PLMN (e.g. in the case of Inter-PLMN HO). |
| S4 | It provides related control and mobility support between GPRS Core and the 3GPP |
| | Anchor function of Serving GW. In addition, if Direct Tunnel is not established, it |
| | provides the user plane tunneling. |
| S5 | It provides user plane tunneling and tunnel management between Serving GW and |
| | PDN GW. It is used for Serving GW relocation due to UE mobility and if the |
| | Serving GW needs to connect to a non-collocated PDN GW for the required PDN |
| | connectivity. |
| S11 | Reference point between an MME and an SGW |
| SGi | It is the reference point between the PDN GW and the packet data network. Packet |
| | data network may be an operator external public or private packet data network or |
| | an intra operator packet data network, e.g. for provision of IMS services. This |
| | reference point corresponds to Gi for 3GPP accesses. |

Among the reference points shown in FIG. 1, S2a and S2b correspond to non-3GPP interfaces. S2a is a reference point which provides reliable non-3GPP access and related control and mobility support between PDN GWs to a user plane. S2b is a reference point which provides related control and mobility support between the ePDG and the PDN GW to the user plane.

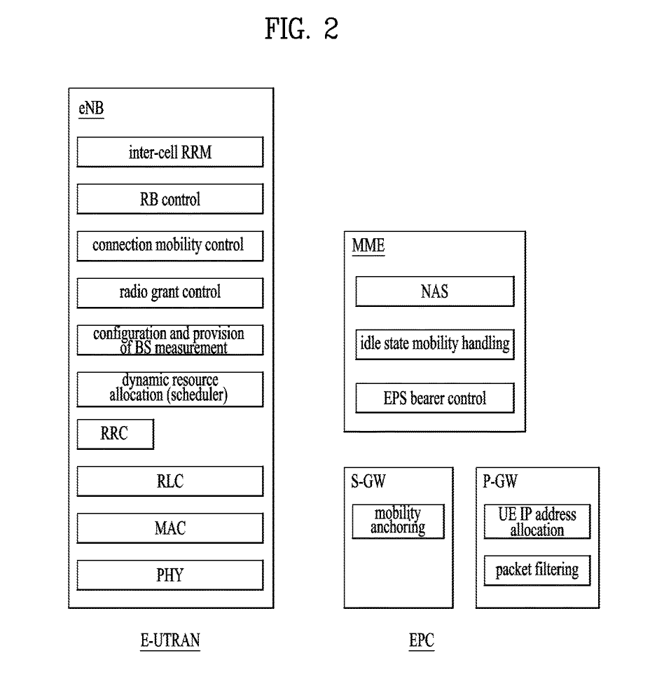

FIG. 2 is a diagram exemplarily illustrating architectures of a typical E-UTRAN and EPC.

As shown in the figure, while radio resource control (RRC) connection is activated, an eNodeB may perform routing to a gateway, scheduling transmission of a paging message, scheduling and transmission of a broadcast channel (BCH), dynamic allocation of resources to a UE on uplink and downlink, configuration and provision of eNodeB measurement, radio bearer control, radio admission control, and connection mobility control. In the EPC, paging generation, LTE IDLE state management, ciphering of the user plane, SAE bearer control, and ciphering and integrity protection of NAS signaling.

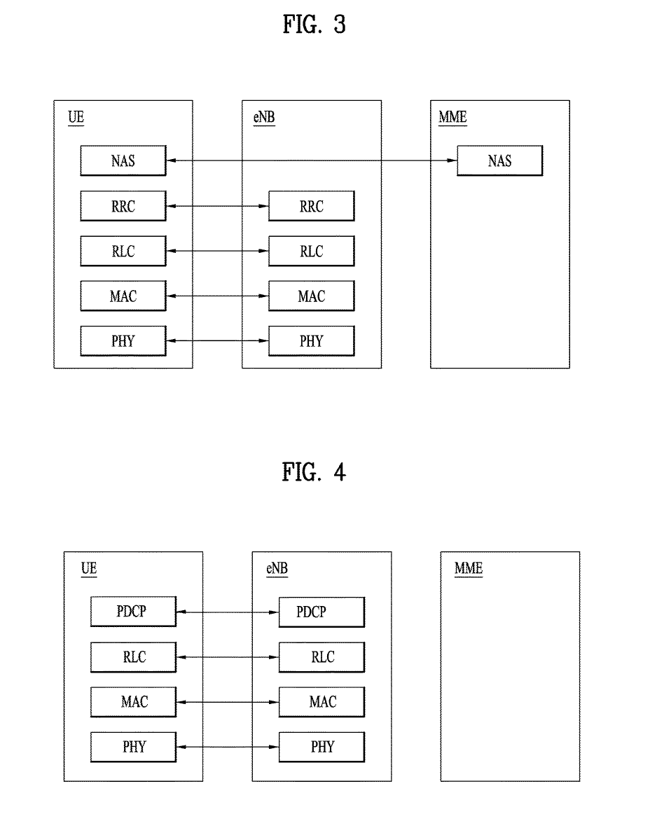

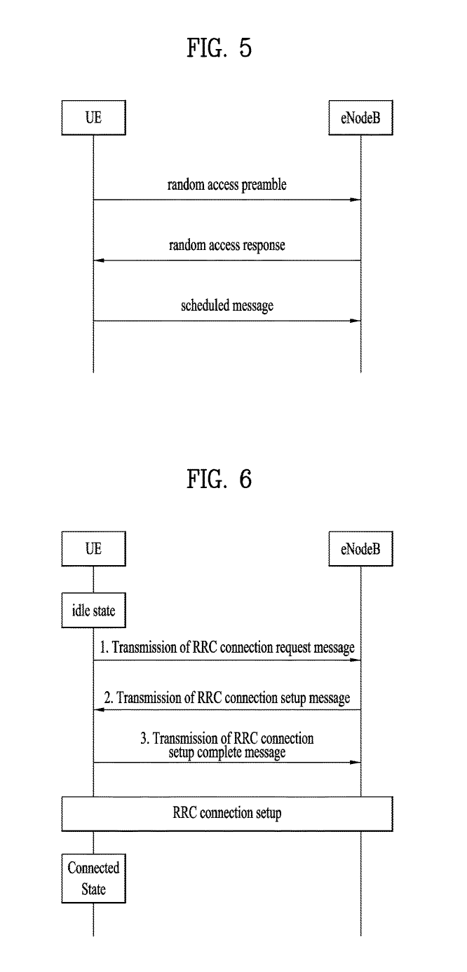

FIG. 3 is a diagram exemplarily illustrating the structure of a radio interface protocol in a control plane between a UE and a base station, and FIG. 4 is a diagram exemplarily illustrating the structure of a radio interface protocol in a user plane between the UE and the base station.

The radio interface protocol is based on the 3GPP wireless access network standard. The radio interface protocol horizontally includes a physical layer, a data link layer, and a networking layer. The radio interface protocol is divided into a user plane for transmission of data information and a control plane for delivering control signaling which are arranged vertically.

The protocol layers may be classified into a first layer (L1), a second layer (L2), and a third layer (L3) based on the three sublayers of the open system interconnection (OSI) model that is well known in the communication system.

Hereinafter, description will be given of a radio protocol in the control plane shown in FIG. 3 and a radio protocol in the user plane shown in FIG. 4.

The physical layer, which is the first layer, provides an information transfer service using a physical channel. The physical channel layer is connected to a medium access control (MAC) layer, which is a higher layer of the physical layer, through a transport channel. Data is transferred between the physical layer and the MAC layer through the transport channel. Transfer of data between different physical layers, i.e., a physical layer of a transmitter and a physical layer of a receiver is performed through the physical channel.

The physical channel consists of a plurality of subframes in the time domain and a plurality of subcarriers in the frequency domain. One subframe consists of a plurality of symbols in the time domain and a plurality of subcarriers. One subframe consists of a plurality of resource blocks. One resource block consists of a plurality of symbols and a plurality of subcarriers. A Transmission Time Interval (TTI), a unit time for data transmission, is 1 ms, which corresponds to one subframe.

According to 3GPP LTE, the physical channels present in the physical layers of the transmitter and the receiver may be divided into data channels corresponding to Physical Downlink Shared Channel (PDSCH) and Physical Uplink Shared Channel (PUSCH) and control channels corresponding to Physical Downlink Control Channel (PDCCH), Physical Control Format Indicator Channel (PCFICH), Physical Hybrid-ARQ Indicator Channel (PHICH) and Physical Uplink Control Channel (PUCCH).

The second layer includes various layers.

First, the MAC layer in the second layer serves to map various logical channels to various transport channels and also serves to map various logical channels to one transport channel The MAC layer is connected with an RLC layer, which is a higher layer, through a logical channel. The logical channel is broadly divided into a control channel for transmission of information of the control plane and a traffic channel for transmission of information of the user plane according to the types of transmitted information.

The radio link control (RLC) layer in the second layer serves to segment and concatenate data received from a higher layer to adjust the size of data such that the size is suitable for a lower layer to transmit the data in a radio interval.

The Packet Data Convergence Protocol (PDCP) layer in the second layer performs a header compression function of reducing the size of an IP packet header which has a relatively large size and contains unnecessary control information, in order to efficiently transmit an IP packet such as an IPv4 or IPv6 packet in a radio interval having a narrow bandwidth. In addition, in LTE, the PDCP layer also performs a security function, which consists of ciphering for preventing a third party from monitoring data and integrity protection for preventing data manipulation by a third party.

The Radio Resource Control (RRC) layer, which is located at the uppermost part of the third layer, is defined only in the control plane, and serves to configure radio bearers (RBs) and control a logical channel, a transport channel, and a physical channel in relation to reconfiguration and release operations. The RB represents a service provided by the second layer to ensure data transfer between a UE and the E-UTRAN.

If an RRC connection is established between the RRC layer of the UE and the RRC layer of a wireless network, the UE is in the RRC Connected mode. Otherwise, the UE is in the RRC Idle mode.

Hereinafter, description will be given of the RRC state of the UE and an RRC connection method. The RRC state refers to a state in which the RRC of the UE is or is not logically connected with the RRC of the E-UTRAN. The RRC state of the UE having logical connection with the RRC of the E-UTRAN is referred to as an RRC_CONNECTED state. The RRC state of the UE which does not have logical connection with the RRC of the E-UTRAN is referred to as an RRC_IDLE state. A UE in the RRC_CONNECTED state has RRC connection, and thus the E-UTRAN may recognize presence of the UE in a cell unit. Accordingly, the UE may be efficiently controlled. On the other hand, the E-UTRAN cannot recognize presence of a UE which is in the RRC_IDLE state. The UE in the RRC_IDLE state is managed by a core network in a tracking area (TA) which is an area unit larger than the cell. That is, for the UE in the RRC_IDLE state, only presence or absence of the UE is recognized in an area unit larger than the cell. In order for the UE in the RRC_IDLE state to be provided with a usual mobile communication service such as a voice service and a data service, the UE should transition to the RRC_CONNECTED state. A TA is distinguished from another TA by a tracking area identity (TAI) thereof. A UE may configure the TAI through a tracking area code (TAC), which is information broadcast from a cell.

When the user initially turns on the UE, the UE searches for a proper cell first. Then, the UE establishes RRC connection in the cell and registers information thereabout in the core network. Thereafter, the UE stays in the RRC_IDLE state. When necessary, the UE staying in the RRC_IDLE state selects a cell (again) and checks system information or paging information. This operation is called camping on a cell. Only when the UE staying in the RRC_IDLE state needs to establish RRC connection, does the UE establish RRC connection with the RRC layer of the E-UTRAN through the RRC connection procedure and transition to the RRC_CONNECTED state. The UE staying in the RRC_IDLE state needs to establish RRC connection in many cases. For example, the cases may include an attempt of a user to make a phone call, an attempt to transmit data, or transmission of a response message after reception of a paging message from the E-UTRAN.

The non-access stratum (NAS) layer positioned over the RRC layer performs functions such as session management and mobility management.

Hereinafter, the NAS layer shown in FIG. 3 will be described in detail.

The eSM (evolved Session Management) belonging to the NAS layer performs functions such as default bearer management and dedicated bearer management to control a UE to use a PS service from a network. The UE is assigned a default bearer resource by a specific packet data network (PDN) when the UE initially accesses the PDN. In this case, the network allocates an available IP to the UE to allow the UE to use a data service. The network also allocates QoS of a default bearer to the UE. LTE supports two kinds of bearers. One bearer is a bearer having characteristics of guaranteed bit rate (GBR) QoS for guaranteeing a specific bandwidth for transmission and reception of data, and the other bearer is a non-GBR bearer which has characteristics of best effort QoS without guaranteeing a bandwidth. The default bearer is assigned to a non-GBR bearer. The dedicated bearer may be assigned a bearer having QoS characteristics of GBR or non-GBR.

A bearer allocated to the UE by the network is referred to as an evolved packet service (EPS) bearer. When the EPS bearer is allocated to the UE, the network assigns one ID. This ID is called an EPS bearer ID. One EPS bearer has QoS characteristics of a maximum bit rate (MBR) and/or a guaranteed bit rate (GBR).

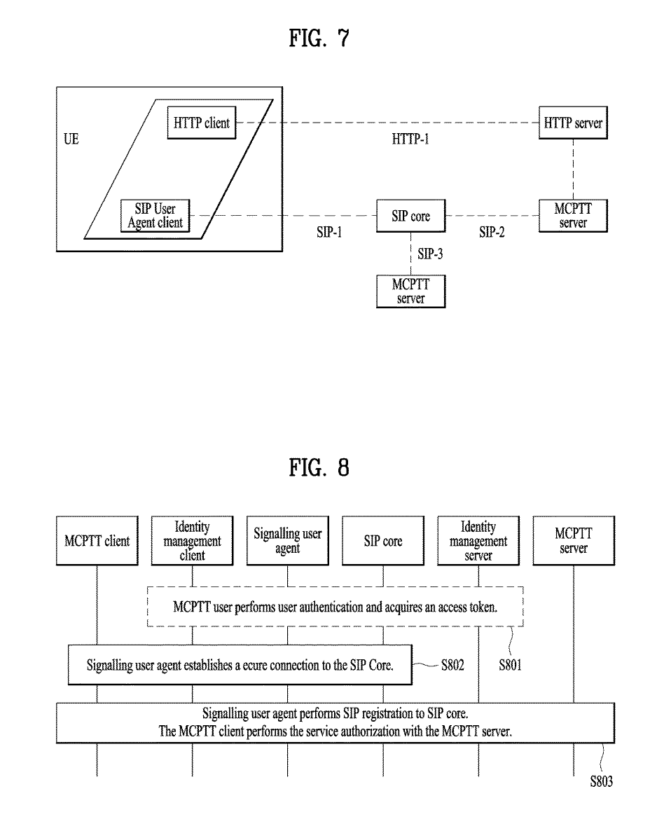

FIG. 5 is a flowchart illustrating a random access procedure in 3GPP LTE.

The random access procedure is used for a UE to obtain UL synchronization with an eNB or to be assigned a UL radio resource.

The UE receives a root index and a physical random access channel (PRACH) configuration index from an eNodeB. Each cell has 64 candidate random access preambles defined by a Zadoff-Chu (ZC) sequence. The root index is a logical index used for the UE to generate 64 candidate random access preambles.

Transmission of a random access preamble is limited to a specific time and frequency resources for each cell. The PRACH configuration index indicates a specific subframe and preamble format in which transmission of the random access preamble is possible.

The UE transmits a randomly selected random access preamble to the eNodeB. The UE selects a random access preamble from among 64 candidate random access preambles and the UE selects a subframe corresponding to the PRACH configuration index. The UE transmits the selected random access preamble in the selected subframe.

Upon receiving the random access preamble, the eNodeB sends a random access response (RAR) to the UE. The RAR is detected in two steps. First, the UE detects a PDCCH masked with a random access (RA)-RNTI. The UE receives an RAR in a MAC (medium access control) PDU (protocol data unit) on a PDSCH indicated by the detected PDCCH.

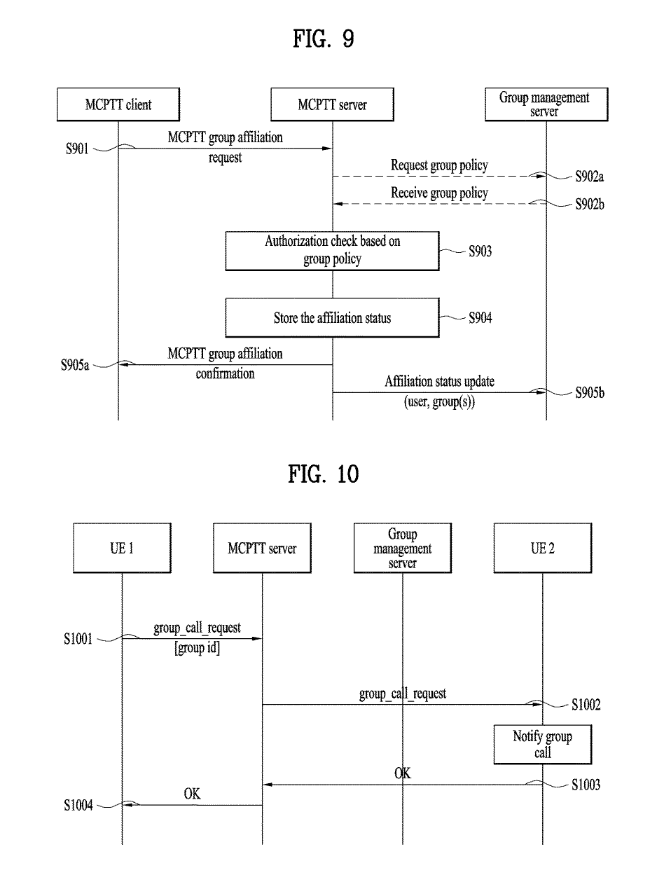

FIG. 6 illustrates a connection procedure in a radio resource control (RRC) layer.

As shown in FIG. 6, the RRC state is set according to whether or not RRC connection is established. An RRC state indicates whether or not an entity of the RRC layer of a UE has logical connection with an entity of the RRC layer of an eNodeB. An RRC state in which the entity of the RRC layer of the UE is logically connected with the entity of the RRC layer of the eNodeB is called an RRC connected state. An RRC state in which the entity of the RRC layer of the UE is not logically connected with the entity of the RRC layer of the eNodeB is called an RRC idle state.

A UE in the Connected state has RRC connection, and thus the E-UTRAN may recognize presence of the UE in a cell unit. Accordingly, the UE may be efficiently controlled. On the other hand, the E-UTRAN cannot recognize presence of a UE which is in the idle state. The UE in the idle state is managed by the core network in a tracking area unit which is an area unit larger than the cell. The tracking area is a unit of a set of cells. That is, for the UE which is in the idle state, only presence or absence of the UE is recognized in a larger area unit. In order for the UE in the idle state to be provided with a usual mobile communication service such as a voice service and a data service, the UE should transition to the connected state.

When the user initially turns on the UE, the UE searches for a proper cell first, and then stays in the idle state. Only when the UE staying in the idle state needs to establish RRC connection, the UE establishes RRC connection with the RRC layer of the eNodeB through the RRC connection procedure and then performs transition to the RRC connected state.

The UE staying in the idle state needs to establish RRC connection in many cases. For example, the cases may include an attempt of a user to make a phone call, an attempt to transmit data, or transmission of a response message after reception of a paging message from the E-UTRAN.

In order for the UE in the idle state to establish RRC connection with the eNodeB, the RRC connection procedure needs to be performed as described above. The RRC connection procedure is broadly divided into transmission of an RRC connection request message from the UE to the eNodeB, transmission of an RRC connection setup message from the eNodeB to the UE, and transmission of an RRC connection setup complete message from the UE to eNodeB, which are described in detail below with reference to FIG. 6.

1) When the UE in the idle state desires to establish RRC connection for reasons such as an attempt to make a call, a data transmission attempt, or a response of the eNodeB to paging, the UE transmits an RRC connection request message to the eNodeB first.

2) Upon receiving the RRC connection request message from the UE, the ENB accepts the RRC connection request of the UE when the radio resources are sufficient, and then transmits an RRC connection setup message, which is a response message, to the UE.

3) Upon receiving the RRC connection setup message, the UE transmits an RRC connection setup complete message to the eNodeB. Only when the UE successfully transmits the RRC connection setup message, does the UE establish RRC connection with the eNodeB and transition to the RRC connected mode.

MCPTT(Mission Critical Push To Talk)

MCPTT is to allow PTT (Push to Talk) to be used in an LTE network under the status such as disaster. MCPTT service may be categorized into an on-network mode (or on-network operation mode or on-network use or on-network MCPTT service) and an off-network mode (or off-network operation mode or off-network use or off-network MCPTT service).

The on-network MCPTT service is MCPTT service in which communication is performed through network infrastructure, and includes communication performed by a UE through network infrastructure within network coverage (that is, which is served by E-UTRAN) and communication performed by a UE-to-Network Relay through network infrastructure out of coverage (that is, which is not served by E-UTRAN).

The off-network MCPTT service is provided using ProSe discovery and a ProSe communication path. The off-network MCPTT service may be used when the UE is out of network coverage but may be used even when the UE is within network coverage.

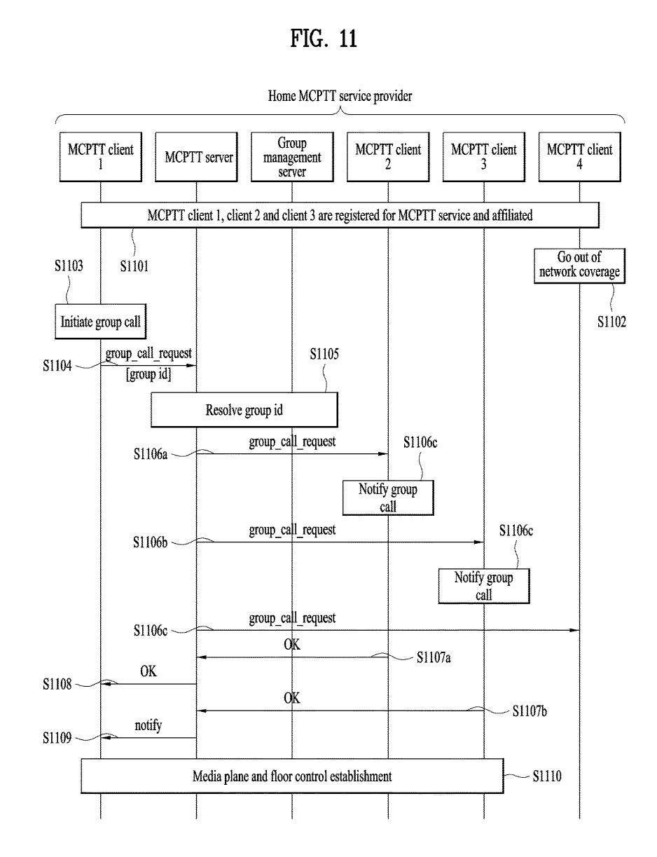

A signaling plane between a network and a UE for MCPTT service is shown in FIG. 7.

In FIG. 7, SIP-1 is a reference point which exists between MCPTT UE SIP User Agent Client and the SIP core. The SIP core may be regarded as IMS over the present invention. SIP-1 uses a 3GPP Gm reference point. SIP-1 is used for SIP registration, authentication and security, event subscription and notification, overload control, session management and media negotiation, etc. SIP-2 is a reference point which exists between SIP core and MCPTT server, and uses a 3GPP ISC interface. SIP-2 is used for notification of SIP registration from MCPTT UE to MCPTT server, authentication and security, event subscription and notification, overload control, session management and media negotiation, etc. SIP-3 is a reference point between SIP core and SIP core, and is used for event subscription and notification, session management and media negotiation, etc.

Subsequently, HTTP-1 is a reference point which exists MCPTT UE HTTP client and the HTTP server, and uses a 3GPP Ut reference point. HTTP-1 is based on HTTP (e.g., protected using SSL, TLS, etc.), and provides a group management function (e.g., transfer support of user profile/configuration information between UE and network). HTTP-2 is based on HTTP (e.g., protected using SSL, TLS, etc.), and provides a group management function (e.g., transfer support of user profile/configuration information between network entities).

A user authentication and registration procedure for MCPTT service is illustrated in FIG. 8. In step S801, an identity management client initiates a user authentication procedure. An MCPTT user provides his/her user credentials (e.g., Biometrics, secureID, username/password) to receive verification from the identity management server. In step S802, a signaling user agent within the UE forms secure connection to the SIP core for SIP level authentication and registration. In step S803, the signaling user agent completes SIP level registration with the SIP core and third-party registration with the MCPTT server. The MCPTT client within the UE performs MCPTT service authorization. To this end, the result of the step S801 may be used. The MCPTT client is a functional entity that is operated as a user agent for all MCPTT application transactions in the MCPTT UE.

MCPTT group member may mean a UE allowed to transmit a signal for group communication to a specific MCPTT group or receive a group communication signal. Affiliation to a specific group may be categorized into explicit affiliation in which MCPTT user provides an interest to one or more MCPTT groups and MCPTT authentication user may remotely correct affiliation of another user to MCPTT group and implicit affiliation in which affiliations to MCPTT are determined through configurations and policies. A procedure of performing explicit affiliation is as illustrated in FIG. 9. Referring to FIG. 9, in step S901, the MCPTT client within the UE requests the MCPTT server to affiliate to one group or a plurality of groups. In step S902a, the MCPTT server identifies whether a group policy for the requested group is locally cached therein. If the MCPTT server does not store the group policy therein, the MCPTT server requests the group management server of the group policy. The group policy includes information as to users authenticated/granted to have affiliated to group(s), a priority of a user, and other meta-data. In step S902b, the MCPTT server acquires the group policy from the group management server. In step S903, the MCPTT server identifies whether the MCPTT client has been authenticated/granted to have affiliated to the requested group(s), based on the group policy. In step S904, if the user of the MCPTT client has been authenticated/granted to have affiliated to the requested group(s), the MCPTT server stores an affiliation status of the user for the requested group(s). In step S905a, the MCPTT server confirms affiliation to the MCPTT client. In step S905b, the MCPTT server notifies the group management server that the affiliation status of the user for the group(s) has been updated. The step S905a and the step S905b may be performed in parallel, or may be performed in any order. In this way, the MCPTT server and/or the group management server may store/manage group members affiliated to the MCPTT group.

In respect of the aforementioned MCPTT, a method for allowing an affiliated MCPTT group member, which does not participate in/join an MCPTT group call due to out-of-network coverage during MCPTT group call setup or another higher priority call, to participate in/join/be added to the MCPTT group call will be described. The following description may be applied to a UE which performs communication with a UE-to-Network Relay through network infrastructure although is out-of-network coverage, and a UE which does not receive a network connection service through a UE-to-Network Relay while is out-of-network coverage.

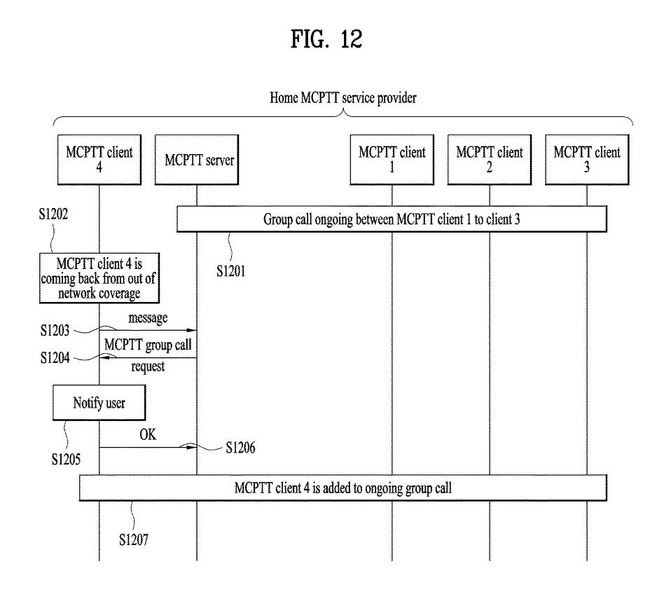

One embodiment of the present invention is illustrated in FIG. 10. A UE 1 and a second UE 2 may be affiliated MCPTT members. The UE may transmit a group call request or predetermined message to the MCPTT server (S1001). In this case, the group call request or predetermined message may include information (e.g., group ID, etc.) for identifying groups. The MCPTT server may transmit a group call request to a UE (second UE in FIG. 10) corresponding to the requested group member (S1002). The second UE may recognize a group call and transmit OK response to the group call (S1003). The OK response may be transmitted to the UE (S1004). The MCPTT server may be operated, as follows, for the UE which is a member which does not join the group call due to various reasons which will be described later.

The MCPTT server may determine whether to add the UE to (or whether to allow the UE to participate in/join) an ongoing group call. If the MCPTT server determines to add the UE to the ongoing group call, the MCPTT server may transmit information (e.g., ongoing group call alarm message or group call joining request message or predetermined message which will be described later) on the ongoing group call to the UE. The MCPTT server may receive OK response to the ongoing group call.

In this case, the determination as to whether to add the UE to the ongoing group call may be performed by receiving the information on the group call from the UE. For example, if the group call request is received from the UE, the MCPTT server may determine whether to add the UE, which has requested the group call request, to the ongoing group call. That is, the information on the group call may be the group call request. The information on the group call may be transmitted after the out-of-coverage status is changed to the in-coverage status.

The procedure/operation related to the operation as to whether to add the UE to the ongoing group call may be performed in a group call setup procedure illustrated in FIG. 11 or a late entry call procedure illustrated in FIG. 12. In the above-described description, the UE may correspond to MCPTT client 1 in FIG. 11 or MCPTT client 4 in FIG. 12.

Referring to FIG. 11, in step S1101, MCPTT users who are MCPTT client 1, client 2, client 3 and client 4 have completed registration to receive MCPTT service and performed affiliation to their interested group. The registration may be performed by the procedure described in FIG. 8. Also, MCPTT group affiliation may be performed by the procedure described in FIG. 9. In step S1103, the user of the MCPTT client 1 may initiate MCPTT group call for a random group. To this end, a group may be selected. This group may be identified by a group identifier. In step S1104, the MCPTT client 1 may transmit MCPTT group call request to the MCPTT server through SIP core which hosts the group selected by the user.

In step S1105, the MCPTT server identifies whether group call initiation of the user of the MCPTT client 1 has been authenticated. If the group call initiation has been authenticated, the MCPTT server identifies whether the group call of the group is an ongoing status. If the group call is the ongoing status, the MCPTT server adds the MCPTT client 1 to the legacy MCPTT group call and notifies the MCPTT client 1 that MCPTT group call for the initiation requested group is already ongoing. If the group call is not the ongoing status, the MCPTT server performs a task of resolving the group identifier to determine members of the initiation requested group and their affiliation status. This task may be performed based on information acquired from the group management server. However, if the MCPTT server stores the information, the information may be used.

In steps S1106a and S1106b, the MCPTT server transmits an MCPTT group call request, which provides the same media type as that included in the request received from the MCPTT client 1 or a subset of the media type, to affiliated group members of the group through the SIP core. The MCPTT server may determine the affiliated group members for the group through step S1105. In step S1106c, the MCPTT client 2 and client 3 have received the MCPTT group call request and thus notify the MCPTT user that the group call has been received. On the other hand, the MCPTT client 4 may get out of network coverage in step S1102. Therefore, the MCPTT client 4 fails to receive the MCPTT group call request.

In steps S117a and 1107b, the MCPTT client which has received the MCPTT group call request transmits OK response or acknowledgment for call setup to the MCPTT server. In step S1108, the MCPTT server transmits OK response, which includes the selected media type, to the MCPTT client 1 to indicate successful call establishment. The step S1108 may be performed based on the condition for performing a call at any time after the step S1106c and before the step S1109. In the step S1109, if the MCPTT user who has initiated a call has requested acknowledgement from the affiliated MCPTT group members but there is a member which has not sent acknowledgement for call setup until a configured time (i.e., acknowledged call setup timeout) passes, the MCPTT server may continue to perform the group call or not. If there is a member which has not sent acknowledgement for call setup, the MCPTT server may notify the MCPTT client 1 that all members have not responded to the call setup.

In step S1110, the MCPTT client 1, client 2 and client 3 establishes/generates a media plane for communication. MCPTT floor participants within each UE, that is, MCPTT floor participant 1, floor participant 2 and floor participant 3 exchange floor control information with one another. For example, the MCPTT client 1 receives floor granted information through the generated media plane, and the other MCPTT clients of the corresponding group call receives floor taken information. Therefore, the MPCTT client 1 may notify the MCPTT user that floor control is available, that is, media may be transmitted, and the other MCPTT clients may receive media.

The late entry call procedure is illustrated in FIG. 12. Each step of FIG. 12 may be performed when it is recognized/determined that a User/UE which corresponds to the affiliated group member list but does not correspond to the User/UE list may join the group call. Referring to FIG. 12, in step S1201, the MCPTT client 1, client 2 and client 3 are performing MCPTT group call for a random group. This group call may be set up by the group call setup procedure of FIG. 11. In step S1202, the MCPTT client 4 (i.e., MCPTT UE 4) enters network coverage from out-of-network coverage. In step S1203, the MCPTT client 4 a message, which allows the network to recognize that the network may join the group call, to the network. This message may be one of messages of stateless methods i), ii), iii), v), vii) and viii), which will be described later. The MCPTT server may recognize/determine that the MCPTT client 4 should join/be added to/participate in the ongoing group call (or determine late entry for the MCPTT client 4). Since the MCPTT server knows (or stores/manages) the affiliated group members for the ongoing group call (or for the group of the ongoing group call) and group members who join the group call, the MCPTT server recognizes/determines that the MCPTT client 4 is the affiliated group member for the group call (or for the group of the group call) but does not join the group call.

Or, the MCPTT server may recognize/determine that the MCPTT client 4 may join the group call through one or more of the stateless methods iv) and vi). Or, the MCPTT server may recognize/determine that the MCPTT client 4 may join the MCPTT group call explicitly or implicitly.

In step S1204, the MCPTT server transmits MCPTT group call request to the MCPTT client 4 through the SIP core. The request includes provision of an identifier of the group that requests join and one or more media types. In step S1205, the user of the MCPTT client 4 is notified that the group call has been received. In step S1206, if the user of the MCPTT client 4 accepts the received group call, the MCPTT client 4 transmits OK response, which includes the selected media type, to the MCPTT server. In step S1207, the MCPTT client 4 is added to the ongoing group call. The users of another MCPTT clients, who join the group, may be notified that the MMCPTT client 4 has joined the group call.

Although the MCPTT server and the group management server are configured separately from each other in the aforementioned description, they may be co-located. Alternatively, the MCPTT server may serve as the group management server. Also, although all the group members belong to the same MCPTT system in the aforementioned description, members who belong to a specific group may belong to their respective MCPTT systems different from each other. This is applied to the following description. Through the aforementioned procedure, the MCPTT server may know MCPTT Users (or MCPTT group member or affiliated MCPTT group member or MCPTT UE or MCPTT client) who join the ongoing MCPTT group call. Alternatively, the MCPTT server may store/manage the MCPTT Users.

In the aforementioned description, the MCPTT server may allow a specific UE to join/be added to the MCPTT group call. As a method for determining this, one of the following methods i) to viii) may be used (stateless method).

i) Information indicating that the affiliated MCPTT group member is available for the MCPTT group call (or desires to participate in/join the MCPTT group call) may be transmitted to the MCPTT server, and the MCPTT server which has received the information may determine whether to add the UE to the ongoing group call.

ii) As the affiliated MCPTT group member is registered or re-registered in the MCPTT server, the MCPTT server may determine whether to add the UE to the ongoing group call. Re-registration is periodically performed to indicate that the UE/User is available for connection to the network, and may be referred to as periodic registration. If the member which has not been available for connection to the network becomes available for connection to the network during registration or re-registration, information (i.e., network connection status change/switching related information) indicating this fact is included in the registration or re-registration message. For this reason, the MCPTT server may recognize/determine that the member which could not participate in/join the group call due to the non-available connection to the network may currently participate in/join the group call.

iii) Instead of the registration or re-registration, a message indicating that the member is available for connection to the network may be transmitted to the MCPTT server. Particularly, if the member which is not available for connection to the network becomes available for connection to the network, information indicating such a fact is included in the message explicitly or implicitly. Alternatively, the message may indicate the information. For this reason, the MCPTT server may recognize/determine that the member could not participate in/join the group call due to the non-available connection to the network before but now could participate in/join the group call.

As another example, determination as to whether to add the UE to the ongoing group call may be performed by determination of the server. In other words, determination as to whether to add the UE to the ongoing group call may be performed when the MCPTT server recognizes one or more of end of the group call to which the UE belongs, non-participation of the UE in the ongoing group call, and non-participation of the UE in the ongoing group call despite that the UE may join the ongoing group call.

Each case will be described in detail. iv) If the group call in which the affiliated MCPTT group member joins or receives has ended or if the number of maximum MCPTT group calls that may be participated or received by the affiliated MCPTT group member is upgraded, and if the MCPTT server recognizes/determines that the ongoing MCPTT group call in which the affiliated MCPTT group member required to join the ongoing group call does not participate exists, the MCPTT server may determine whether to add the UE to the ongoing group call.

v) Alternatively, as the affiliated MCPTT group member notifies the MCPTT server that use of the off-network mode ends (with respect to the group which desires to perform the MCPTT group call or with respect to all the MCPTT group calls) or notifies the MCPTT server that switching/change from the off-network mode to the on-network mode (with respect to the group which desires to perform the MCPTT group call or with respect to all the MCPTT group calls), the MCPTT server may determine whether to add the UE to the ongoing group call.

vi) Although available connection of the affiliated MCPTT group member to the network (or acquisition of connection to the network) has been acquired from another network node (e.g., PCRF, P-GW, Identity Management Server, Group Management Server, Configuration Management Server, etc.), if the MCPTT server recognizes/determines that the ongoing MCPTT group call in which the affiliated MCPTT group member required to join the ongoing group call does not participate exists, the MCPTT server may determine whether to add the UE to the ongoing group call.

vii) As the affiliated MCPTT group member requests the network to initiate/generate a group call for another MCPTT group not the MCPTT group call, if the MCPTT server recognizes/determines that the member is available, the MCPTT server may determine whether to add the UE to the ongoing group call.

viii) As the MCPTT server has sent a group call initiation/generation/invitation request for another MCPTT group not the MCPTT group call and has received a response to the request from the affiliated MCPTT group member, if the MCPTT server recognizes/determines that the member is available, the MCPTT server may determine whether to add the UE to the ongoing group call.

Hereinafter, if the affiliated MCPTT group member which does not participate in/join the MCPTT group call during MCPTT group call setup becomes the status that it may participate in/join the MCPTT group call, as a method for allowing the affiliated MCPTT group member to participate in/add to/join the MCPTT group call, a stateful method will be described.

The MCPTT server may generate a list of the affiliated MCPTT group members that cannot (do not) participate in/join the group call during MCPTT group call setup.

In this case, members stored/managed in the list are affiliated MCPTT group members who do not transmit ACK for setup request reception. Also, if the affiliated MCPTT group member has received the setup request but cannot participate in/join the group call, the affiliated MCPTT group member may include information indicating that the MCPTT group member cannot participate in/join the group call in ACK while transmitting the ACK, or may transmit NACK. Even in this case, the members are stored/managed in the list.

If the affiliated MCPTT group members are not required of acknowledgement for setup request reception during MCPTT group call setup, the members stored/managed in the list may be members explicitly or implicitly recognized/determined by the MCPTT server that the MCPTT server cannot participate in/join the group call during the group call setup. In this case, the recognition/determination may depend on one or more of the following methods. The affiliated MCPTT group member may not perform re-registration to the MCPTT server for a certain time. In this case, the MCPTT server may determine that the member cannot participate in/join the group call during the group call setup, by storing/managing/recognizing non-available connection of the member to the network. Alternatively, the affiliated MCPTT group member may not perform registration to the MCPTT server. In this case, the MCPTT server may determine that the member cannot participate in/join the group call during the group call setup, by storing/managing/recognizing non-available connection of the member to the network. Or, as the affiliated MCPTT group member notifies the MCPTT server that the off-network mode is used (with respect to the group which desires to perform the MCPTT group call or with respect to all the MCPTT group calls), the MCPTT server which stores/manages/recognizes the use of the off-network mode may determine that the member cannot participate in/join the group call. Or, the MCPTT server may determine that the member cannot participate in/join the group call due to a higher priority call in which the affiliated MCPTT group member participates. Or, if the number of maximum MCPTT group calls that may be participated or received by the affiliated MCPTT group member is already satisfied, that is, if the member already participates in or receives the group call as much as the maximum group calls, the MCPTT server may determine that the member cannot participate in/join the group call. Or, non-available connection of the affiliated MCPTT group member to the network (or the loss of connection to the network) has been acquired from another network node (e.g., PCRF, P-GW, etc.) and stored/managed/recognized, whereby the MCPTT server may determine that the member cannot participate in/join the group call during the group call setup.

Subsequently, the MCPTT server may perform/complete/end the MCPTT group call setup. However, list generation of the MCPTT server may be performed after the MCPTT group call setup. If the MCPTT server recognizes/determines that the affiliated MCPTT group member belonging to the list managed by itself can participate in/join the MCPTT group call (or recognizes/determines that the member is available for the MCPTT group call), the MCPTT server may allow the member to participate in/join/be added to the group call. To allow the member to participate in/join/be added to the group call, the MCPTT server may transmit a group call participation request message to the member.

The MCPTT server may explicitly or implicitly recognize/determine that the affiliated MCPTT group member belonging to the list managed by itself can participate in/join the MCPTT group call. In detail, if information indicating that the affiliated MCPTT group member is available for the MCPTT group call (or desires to participate in/join the group call) is transmitted to the MCPTT server, determination as to participation in the MCPTT group call may be performed.

Or, the affiliated MCPTT group member performs registration or re-registration to the MCPTT server, whereby determination as to participation in the MCPTT group call may be performed. In this case, re-registration is periodically performed to indicate that the UE/User is available for connection to the network, and may be referred to as periodic registration. If the member which has not been available for connection to the network becomes available for connection to the network during registration or re-registration, information (i.e., network connection status change/switching related information) indicating this fact may be included in the registration or re-registration message. Or, instead of the registration or re-registration, a message indicating that the member is available for connection to the network or a message indicating that the member which has not been available for connection to the network becomes available for connection to the network may be transmitted to the MCPTT server.

Or, if the higher priority call participated by the affiliated MCPTT group member ends, determination as to participation in the MCPTT group call may be performed.

Or, if it is recognized/determined that the number of MCPTT group calls currently participated or received by the affiliated MCPTT group member is smaller than the number of maximum MCPTT group calls that may be participated or received by the affiliated MCPTT group member, determination as to participation in the MCPTT group call may be performed. This may be recognized/determined as the group call participated or received by the affiliated MCPTT group ends, or may be recognized/determined as the number of maximum MCPTT group calls that may be participated or received by the affiliated MCPTT group member is upgraded.

In the aforementioned description, the MCPTT server manage/store information indicating that the member cannot participate in/join a specific MCPTT group call, in the affiliated MCPTT group member related context/DB, instead of, or simultaneously with, managing the list of the affiliated MCPTT group member that does not participate in/join the specific MCPTT group call.

Also, in the aforementioned description, the MCPTT server may be a physical node or a logical node (or function). Also, the MCPTT server may be a stand-along type, or may be co-located with another network node. The MCPTT server may be referred to as various titles such as MCPTT application server, PTT server, Public safety server, and GCSE application server. The group member may be regarded as UE and/or User.

In the aforementioned description, the information or message indicating that the member which has not been available for connection to the network becomes available for connection to the network may include various types of information explicitly or implicitly as follows.
Information indicating that the member enters network coverage from out of network coverage (this may correspond to only a case that network connection service is not received through UE-to-Network Relay or indicate that the coverage is not served by E-UTRAN).
Previous cell information and current cell information. The previous cell information is in the form of N/A and Null, and indicates there is no cell which is camping-on, and the current cell information includes ID (e.g., ECGI) of the cell which is camping-on and cell ID information acquired from the UE-to-Network Relay in case of connection service to network through the UE-to-Network Relay.

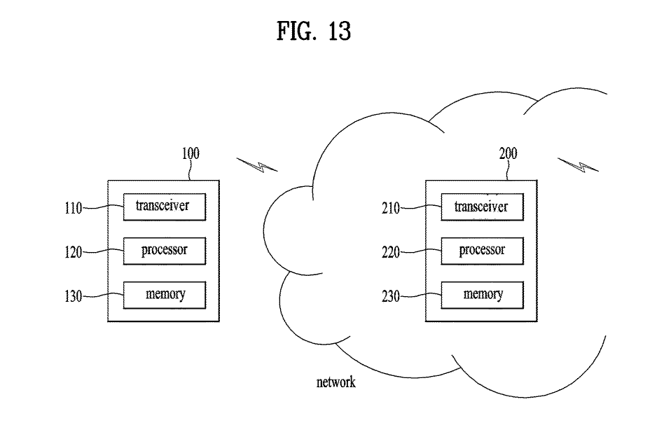

FIG. 13 is a diagram illustrating configurations of a UE and a network node device according to the preferred embodiment of the present invention.

Referring to FIG. 13, a UE 100 according to the present invention may include a transceiving device 110, a processor 120 and a memory 130. The transceiving device 110 may be configured to transmit various signals, data and information to an external device and receive various signals, data and information from the external device. The UE 100 may be connected with the external device through the wire and/or wireless. The processor 120 may control the overall operation of the UE 100, and may be configured to perform a function of operation-processing information to be transmitted to and received from the external device. Also, the processor 120 may be configured to perform a UE operation suggested in the present invention. The memory 130 may store the operation-processed information for a predetermined time, and may be replaced with a buffer (not shown).

Referring to FIG. 13, the network node device 200 according to the present invention may include a transceiving device 210, a processor 220, and a memory 230. The transceiving device 210 may be configured to transmit various signals, data and information to an external device and to receive various signals, data and information from the external device. The network node device 200 may be connected with the external device through the wire and/or wireless. The processor 220 may control the overall operation of the network node device 200, and may be configured to perform a function of operation-processing information to be transmitted to and received from the external device. Also, the processor 220 may be configured to perform a network node operation suggested in the present invention. The memory 230 may store the operation-processed information for a predetermined time, and may be replaced with a buffer (not shown).

Also, the details of the aforementioned UE 100 and the aforementioned network node device 200 may be configured in such a manner that the aforementioned various embodiments of the present invention may independently be applied to the aforementioned UE 100 and the aforementioned network node device 200, or two or more embodiments may simultaneously be applied to the aforementioned UE 100 and the aforementioned network node device 200, and repeated description will be omitted for clarification.

The aforementioned embodiments according to the present invention may be implemented by various means, for example, hardware, firmware, software, or their combination.

If the embodiments according to the present invention are implemented by hardware, the method according to the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiments according to the present invention are implemented by firmware or software, the method according to the embodiments of the present invention may be implemented by a type of a device, a procedure, or a function, which performs functions or operations described as above. A software code may be stored in a memory unit and then may be driven by a processor. The memory unit may be located inside or outside the processor to transmit and receive data to and from the processor through various means which are well known.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. It is also obvious to those skilled in the art that claims that are not explicitly cited in each other in the appended claims may be presented in combination as an embodiment of the present invention or included as a new claim by a subsequent amendment after the application is filed.

### INDUSTRIAL APPLICABILITY

Although the aforementioned various embodiments of the present invention have been described based on the 3GPP system, the aforementioned embodiments may be applied to various mobile communication systems.

1. A method for establishing a group call in an MCPTT (Mission Critical Push To Talk) server in a wireless communication system, the method comprising the steps of:
determining whether to add a user equipment (UE) to an ongoing group call;
transmitting information on the ongoing group call to the UE if it is determined that the UE is added to the ongoing group call; and
receiving an OK response to the ongoing group call from the UE.

2. The method according to claim 1, wherein the step of determining whether to add the UE to the ongoing group call is performed by receiving the information on the group call from the UE.

3. The method according to claim 2, wherein the information on the group call is a group call request.

4. The method according to claim 1, wherein the step of determining whether to add the UE to the ongoing group call is performed by receiving information on network connection from the UE.

5. The method according to claim 4, wherein the information on network connection is transmitted after switching from an out of coverage status to an in coverage status.

6. The method according to claim 4, wherein the information on network connection is registration or re-registration to the MCPTT server.

7. The method according to claim 5, wherein the UE is an affiliated MCPTT member.

8. The method according to claim 1, wherein the step of determining whether to add the UE to the ongoing group call is performed when the MCPTT server recognizes one or more of end of the group call to which the UE belongs, non-participation of the UE in the ongoing group call, and non-participation of the UE in the ongoing group call despite that the UE may join the ongoing group call.

9. An MCPTT (Mission Critical Push To Talk) server for establishing a group call in a wireless communication system, the MCPTT server comprising:
a transceiving device; and
a processor,
wherein the processor determines whether to add a user equipment (UE) to an ongoing group call, transmits information on the ongoing group call to the UE if it is determined that the UE is added to the ongoing group call, and receives receiving an OK response to the ongoing group call from the UE.

10. The MCPTT server according to claim 9, wherein the determination as to whether to add the UE to the ongoing group call is performed by receiving the information on the group call from the UE.

11. The MCPTT server according to claim 10, wherein the information on the group call is a group call request.

12. The MCPTT server according to claim 9, wherein the determination as to whether to add the UE to the ongoing group call is performed by receiving information on network connection from the UE.

13. The MCPTT server according to claim 12, wherein the information on network connection is transmitted after switching from an out of coverage status to an in coverage status.

14. The MCPTT server according to claim 12, wherein the information on network connection is registration or re-registration to the MCPTT server.

15. The MCPTT server according to claim 13, wherein the UE is an affiliated MCPTT member.

16. The MCPTT server according to claim 9, wherein the determination as to whether to add the UE to the ongoing group call is performed when the MCPTT server recognizes one or more of end of the group call to which the UE belongs, non-participation of the UE in the ongoing group call, and non-participation of the UE in the ongoing group call despite that the UE may join the ongoing group call.
